(19) United States
(12) Patent Application Publication
(10) Pub. No.: US 2026/0179190 A1
(43) Pub. Date: Jun. 25, 2026

(54) IMAGE PROCESSING DEVICE, LEARNING METHOD, AND INFERENCE METHOD

(71) Applicant: Maxell, Ltd., Kyoto (JP)

(72) Inventor: Hiroyuki TOKUNAGA, Tokyo (JP)

(21) Appl. No.: 19/125,627

(22) PCT Filed: Sep. 19, 2023
(86) PCT No.: PCT/JP2023/033867

§ 371 Date: Apr. 29, 2025

(30) Foreign Application Priority Data
Oct. 31, 2022 (JP) 2022-174815

(51) Int. Cl. G06T 5/60; G06T 5/70

(52) U.S. Cl. CPC G06T 5/60; G06T 5/70; G06T 2207/20081; G06T 2207/20084; G06T 2207/30168

(57) ABSTRACT

An image processing device includes a preprocessing unit configured to convert pixel values of an input image to data of a lower number of bits than the number of bits of the pixel values using a predetermined function having nonlinearity and a network unit configured to perform a convolutional operation with data which is a result of conversion from the preprocessing unit as an input.

### CROSS-REFERENCE TO RELATED APPLICATIONS

This application is the U.S. National Stage entry of International Application No. PCT/JP2023/033867, filed on Sep. 19, 2023, which, in turn, claims priority to JP Patent Application No. 2022-174815, filed on Oct. 31, 2022, both of which are hereby incorporated herein by reference in their entireties for all purposes.

### TECHNICAL FIELD

The present invention relates to an image processing device, a learning method, and an inference method.

### BACKGROUND ART

At the time of capturing an image using an imaging device, when a quantity of ambient light is not sufficient or settings of the imaging device such as a shutter speed, an iris diaphragm, or an ISO sensitivity are not appropriate, a low-quality image may be obtained. There are known techniques of converting a captured low-quality image to a high-quality image through image processing. For example, there are known techniques of image-processing a low-quality image to a high-quality image using machine learning (for example, see Patent Document 1).

### CITATION LIST

### Patent Document

Patent Document 1: U.S. Pat. No. 10,623,756

### SUMMARY OF INVENTION

### Technical Problem

When the aforementioned related art is applied to an edge device, there is need for a decrease in model size. However, when the model size is excessively decreased, it may not be possible to obtain a satisfactory high-quality image. That is, one problem when the model size is decreased is a decrease in accuracy. Accordingly, when an edge device performs image processing from a low-quality image to a high-quality image, it is important to take a balance between a model size and accuracy.

Therefore, an objective of the present invention is to provide a technique capable of enhancing accuracy and efficiency when a low-quality image is processed into a high-quality image using machine learning.

### Solution to Problem

[1] According to an aspect of the present invention for achieving the aforementioned objective, there is provided an image processing device including a preprocessing unit configured to convert pixel values of an input image to data having a lower number of bits than that of the pixel values using a predetermined function having nonlinearity and a network unit configured to perform a convolutional operation with data which is a result of conversion from the preprocessing unit as an input.

[2] According to an aspect of the present invention, in the image processing device according to [1], the network unit includes a pooling layer performing a pooling process on a result of the convolutional operation and an upsampling layer having a symmetric structure with respect to the pooling layer and upsampling the result of the convolutional operation and has a U-Net structure in which the pooling layer and the upsampling layer are connected by a skip connection.

[3] According to an aspect of the present invention, the image processing device according to [1] or [2] further includes a post-processing unit configured to generate a higher-quality image than the image input to the preprocessing unit on the basis of the result of the convolutional operation from the network unit and the image input to the preprocessing unit.

[4] According to an aspect of the present invention, in the image processing device according to any one of [1] to [3], the predetermined function having nonlinearity used for conversion by the preprocessing unit is configured to be approximated by a plurality of functions having linearity.

[5] According to an aspect of the present invention, in the image processing device according to any one of [1] to [4], the predetermined function used for conversion of the number of bits by the preprocessing unit is determined according to a gamma function which is used for a gamma process of the input image.

[6] According to an aspect of the present invention, in the image processing device according to any one of [1] to [5], the network unit performs a batch normalization process of normalizing a data distribution, calculates an activation function, performs a scaling process of multiplication of a predetermined function, and then performs the convolutional operation.

[7] According to an aspect of the present invention, in the image processing device according to any one of [1] to [6], the network unit converts the pixel values to 16 or more bit data as a result of the convolutional operation and quantizes the 16 or more bit data as the result of the convolutional operation to 8 or fewer bit data.

[8] According to an aspect of the present invention, in the image processing device according to [7], the network unit quantizes the data of 16 or more bits acquired as the result of the convolutional operation to 8 or fewer bit data using one method of comparison with a plurality of threshold values and conversion using a predetermined function.

[9] According to an aspect of the present invention, in the image processing device according to any one of [1] to [8], the preprocessing unit converts the pixel values to data of 8 bits, and the network unit performs the convolutional operation with the data of 8 bits which is a result of conversion from the preprocessing unit as an input.

[10] According to another aspect of the present invention, a learning method is provided including a preprocessing step of converting pixel values of a pair of a high-quality image and a low-quality image included in training data to data having a lower number of bits than that of the pixel values using a predetermined function having nonlinearity and a learning step of performing learning for extraction of a noise component superimposed on the low-quality image with data which is a result of conversion from the preprocessing step as an input.

[11] According to another aspect of the present invention, there is provided an inference method including a preprocessing step of converting pixel values of an input image to data of a lower number of bits than the number of bits of the pixel values using a predetermined function having nonlinearity, an inference step of performing inference for extraction of a noise component with data which is a result of conversion from the preprocessing step as an input, and a post-processing step of generating a high-quality output image than the input image by performing a process of relieving nonlinearity on the inferred noise component using an inverse function of the predetermined function having nonlinearity and subtracting the noise component of which nonlinearity has been relieved from the input image.

[12] According to another aspect of the present invention, there is provided a learning method including a preprocessing step of converting pixel values of a pair of a high-quality image and a low-quality image included in training data to data of a lower number of bits than the number of bits of the pixel values using a predetermined function having nonlinearity and a learning step of performing learning for extraction of a noise component superimposed on the low-quality image and conversion using an inverse function of the predetermined function having nonlinearity with data which is a result of conversion from the preprocessing step as an input.

[13] According to another aspect of the present invention, there is provided an inference method including a preprocessing step of converting pixel values of an input image to data of a lower number of bits than the number of bits of the pixel values using a predetermined function having nonlinearity, an inference step of performing inference for extraction of a noise component and conversion using an inverse function of the predetermined function having nonlinearity with data which is a result of conversion from the preprocessing step as an input, and a post-processing step of generating a high-quality output image than the input image by subtracting the inferred noise component from the input image.

### Advantageous Effects of Invention

According to the present invention, it is possible to enhance accuracy and efficiency when a low-quality image is processed into a high-quality image using machine learning.

### BRIEF DESCRIPTION OF DRAWINGS

FIG. 1 A block diagram illustrating an example of a functional configuration of an image processing system according to an embodiment.

FIG. 2 A diagram illustrating functional blocks of a processing unit according to the embodiment.

FIG. 3 A diagram illustrating an example of data that is input to a preprocessing unit according to the embodiment and data that is output by the preprocessing unit.

FIG. 4 A diagram illustrating a first example of a function that is used for conversion by the preprocessing unit according to the embodiment.

FIG. 5 A diagram illustrating a second example of a function that is used for conversion by the preprocessing unit according to the embodiment.

FIG. 6 A diagram illustrating a skip connection of a network unit according to the embodiment.

FIG. 7 A block diagram illustrating an example of a functional configuration of arithmetic blocks of the network unit according to the embodiment.

FIG. 8 A diagram illustrating an example of an activation function according to the embodiment.

FIG. 9 A flowchart illustrating a first example of a process flow in a learning stage according to the embodiment.

FIG. 10 A flowchart illustrating a first example of a process flow in an inference stage according to the embodiment.

FIG. 11 A flowchart illustrating a second example of a process flow in the learning stage according to the embodiment.

FIG. 12 A flowchart illustrating a second example of a process flow in the inference stage according to the embodiment.

FIG. 13 A block diagram illustrating an example of an internal configuration of an image processing device, a learning device, and an inference device according to the embodiment.

### DESCRIPTION OF EMBODIMENTS

### Embodiments

Hereinafter, an exemplary embodiment of an image processing device, a learning method, and an inference method according to an aspect of the present invention will be described in detail with reference to the accompanying drawings. No aspect of the present invention is limited to such an embodiment and includes various modifications or improvements thereof. That is, elements described below include elements that can be easily conceived by those skilled in the art or elements that are substantially the same, and elements described below can be appropriately combined. Various omissions, substitutions, or modifications of elements can be carried out without departing from the gist of the present invention. In the drawings used for the following description, sizes, numbers, and the like of constituent members may be made to be different from actual scales, numbers, and the like of the constituent members in order to allow the constituent members to be easily recognized.

First, the premises of an embodiment will be described below. An image processing device, a learning method, and an inference method according to an embodiment are used in an embedded device such as an Internet of Things (IoT) device. An example of the IoT device is a camera which is an edge device for capturing an image or a video. Since the image processing device, the learning method, and the inference method according to the present embodiment are applied to an edge device, there is need for a decrease in processing load and an increase in processing speed. The edge device such as a camera may have a function of image recognition, object detection, or the like. The present embodiment is not limited to this example and may be realized by a plurality of devices connected via a network.

An image of which the quality has been increased using the image processing device, the learning method, and the inference method according to the present embodiment may be used for appreciation. Object detection may be performed on the basis of an image of which the quality has been increased using the image processing device, the learning method, and the inference method according to the present embodiment. In this case, it is possible to perform object detection more accurately than when object detection is performed on the basis of a low-quality image.

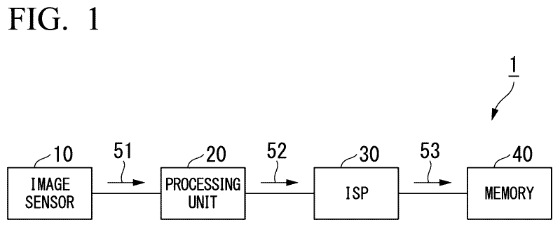

FIG. 1 is a block diagram illustrating an example of a functional configuration of an image processing system according to the embodiment. An example of the functional configuration of the image processing system 1 will be described below with reference to the drawing. The image processing system 1 includes an image sensor 10, a processing unit 20, an ISP 30, and a memory 40.

The image sensor 10 outputs an electrical signal corresponding to an intensity of incident light for each pixel. That is, the image sensor 10 photoelectrically converts an image of a subject formed by an optical system. Specifically, the image sensor 10 includes a CCD image sensor or a CMOS image sensor. The image sensor 10 outputs a first image 51 indicating the captured image of the subject. The first image 51 may be specifically a digital image signal in a RAW format (hereinafter referred to as RAW image data). The RAW image data output from the image sensor 10 may be, for example, data in which a pixel value of each pixel is expressed in 12 [bit] or 14 [bit]. When a pixel value in the present embodiment is expressed in bits, it may include a case in which an effective amount of information included in the data is expressed as a bit value. That is, when data expressed in 12 [bit] or 14 [bit] is converted to 16 [bit] by performing a process such as bit shift in some operations, the data may be expressed in 12 [bit] or 14 [bit] in the present embodiment.

The processing unit 20 acquires a first image 51 output from the image sensor 10. The processing unit 20 performs a predetermined process on the first image 51. The process performed by the processing unit 20 may be specifically a process of converting a low-quality image to a high-quality image (a noise reduction process). The processing unit 20 outputs a second image 52 which is acquired as a result of the process. That is, the second image 52 is a high-quality image which is acquired by removing noise from the image captured by the image sensor 10.

An image signal processor (ISP) 30 acquires the second image 52 output from the processing unit 20. The ISP 30 performs a predetermined process on the second image 52. The predetermined process performed by the ISP 30 may be, for example, black level adjustment, high dynamic range (HDR) combination, exposure adjustment, pixel defect correction, shading correction, demosaicing, white balance adjustment, color correction, or gamma correction. The ISP 30 outputs a third image 53 which is acquired as a result of the process. That is, the third image 53 is a high-quality image acquired by further enhancing the quality of the second image 52.

The memory 40 includes a storage device such as a nonvolatile read only memory (ROM) or a volatile random access memory (RAM). The memory 40 acquires the third image 53 output from the ISP 30. The memory 40 stores the acquired third image 53. The third image 53 stored in the memory 40 is subjected to a predetermined process by a central processing unit (CPU) which is not illustrated. The predetermined process may be displayed on a display unit, output to an external device, or the like.

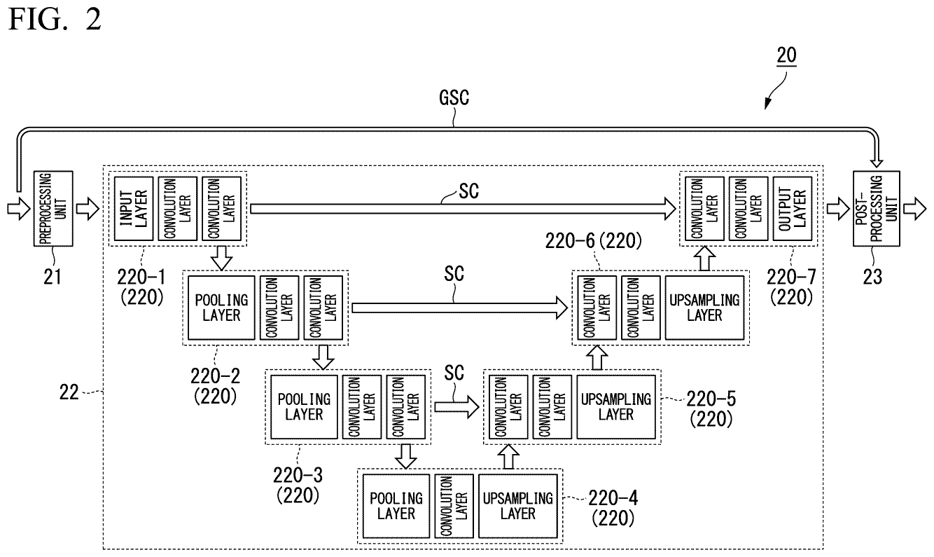

FIG. 2 is a diagram illustrating functional blocks of the processing unit according to the embodiment. Details of functional blocks of the processing unit 20 will be described below with reference to the drawing. In the following description, a device having the configuration of the processing unit 20 may be referred to as an image processing device. The processing unit 20 includes a preprocessing unit 21, a network unit 22, and a post-processing unit 23. The preprocessing unit 21, the network unit 22, and the post-processing unit 23 are connected in series. A first image 51 output from the image sensor 10 is input to the preprocessing unit 21. The first image 51 input to the preprocessing unit 21 is also input to the post-processing unit 23. A path along which the first image 51 output from the image sensor 10 is input to the post-processing unit 23 with flying over (skipping) the preprocessing unit 21 and the network unit 22 is illustrated as a global skip connection GSC.

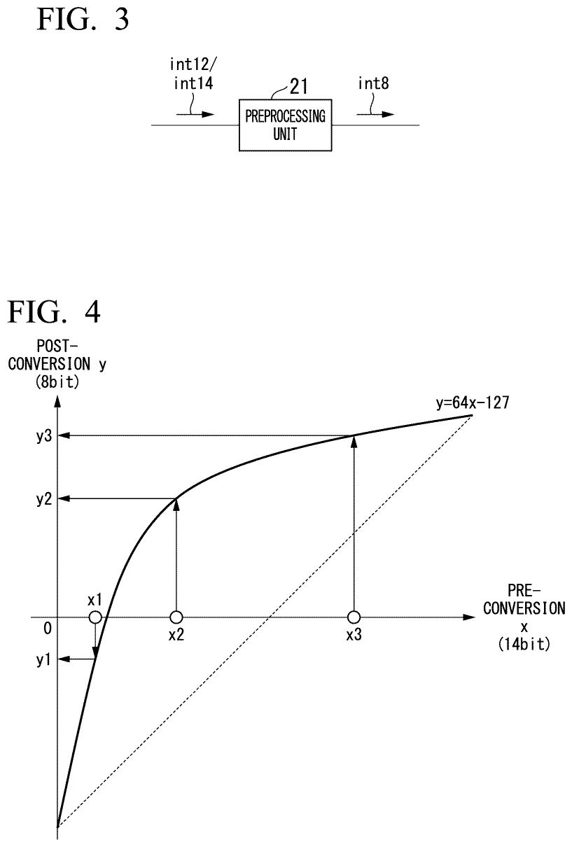

FIG. 3 is a diagram illustrating an example of data input to the preprocessing unit and data output from the preprocessing unit according to the embodiment. Input/output data of the preprocessing unit 21 will be described below with reference to the drawing. A first image 51 output from the image sensor 10 is input to the preprocessing unit 21. As illustrated in the drawing, the first image 51 is data in which pixel values are expressed in 12 [bit] or 14 [bit]. The preprocessing unit 21 performs a process of converting the pixel values to 8 [bit]. As illustrated in the drawing, the preprocessing unit 21 outputs data of 8 [bit] which is a conversion result to a subsequent stage. The preprocessing unit 21 preferably performs conversion to data of 8 [bit] using a predetermined function. In the present embodiment, 8 [bit] is exemplified as a conversion result of the pixel values in the preprocessing unit 21, but the present invention is not limited thereto, and, for example, a lower number of bits such as 4 [bit] or 2 [bit] may be used.

FIG. 4 is a diagram illustrating a first example of a function that is used in conversion by the preprocessing unit according to the embodiment. A first example of the function that is used in conversion by the preprocessing unit 21 will be described below with reference to the drawing. In the drawing, the horizontal axis represents pre-conversion pixel values (14 [bit]), and the vertical axis represents post-conversion pixel values (8 [bit]). The preprocessing unit 21 performs the conversion by applying the illustrated function to the pixel values. Specifically, the preprocessing unit 21 converts x1 which is a pre-conversion pixel value to y1, converts x2 which is a pre-conversion pixel value to y2, and converts x3 which is a pre-conversion pixel value to y3.

When the horizontal axis (pre-conversion pixel value) is x and an initial value of the vertical axis (post-conversion pixel value) is y0, the illustrated function is specifically expressed by y=x\hat{ }γ−y0(γ<1). As illustrated in the drawing, the function used in conversion by the preprocessing unit 21 preferably has nonlinearity. That is, the preprocessing unit 21 can also be said to convert pixel values of an input image (the first image 51) to data of a lower number of bits than the pixel values of the input image using a predetermined function. As illustrated in the drawing, according to the function used in conversion by the preprocessing unit 21, values of a higher number of bits after conversion are assigned to an area with low input signal values (that is, a dark area in an image). This function corresponds to a nonlinear process that is used in a gamma process which is performed by the ISP 30.

In the illustrated example, the range of the vertical axis indicates a range from −128 to +127. However, the function according to the present embodiment is not limited to this example, and the range of the vertical axis can be arbitrarily changed. In the illustrated example, one input pixel value is converted to one pixel value on the basis of a predetermined function, but may be converted to a plurality of pixel values on the basis of a plurality of functions. The plurality of pixel values are expressed in the form of a vector. That is, the preprocessing unit 21 may generate a vectorized output value on the basis of an input image and a plurality of functions.

The predetermined function used in conversion of the number of bits by the preprocessing unit 21 may be determined in advance or may be switched by selection out of a plurality of function candidates. Switching of a function may be performed, for example, at a timing at which a gamma function (a gamma curve) used in a gamma process is switched by the ISP 30. That is, the predetermined function used in conversion of the number of bits by the preprocessing unit 21 may be determined according to a gamma function used in a gamma process of an input image performed by the ISP 30.

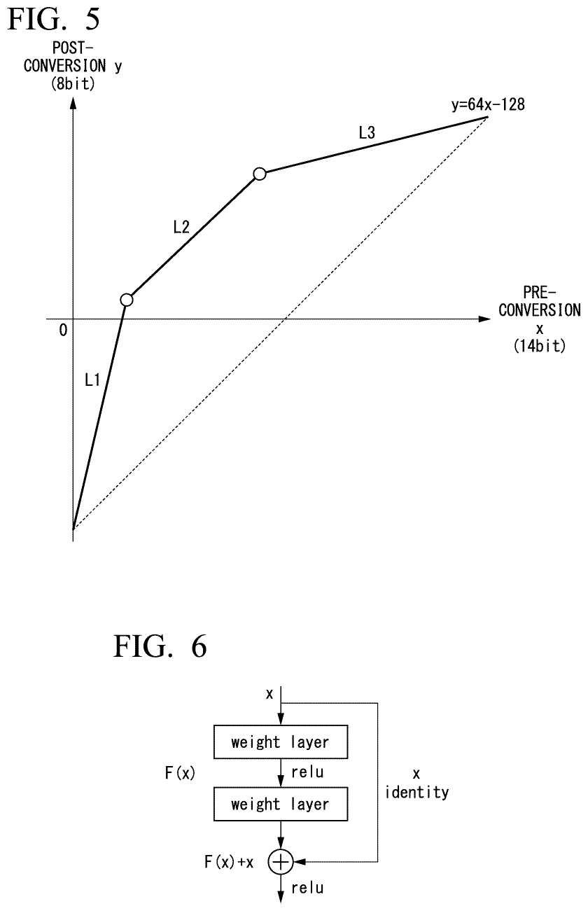

FIG. 5 is a diagram illustrating a second example of the function that is used in conversion by the preprocessing unit according to the embodiment. A second example of the function that is used in conversion by the preprocessing unit 21 will be described below with reference to the drawing. In the drawing, the horizontal axis represents pre-conversion pixel values (14 [bit]), and the vertical axis represents post-conversion pixel values (8 [bit]). The function in the second example is obtained by approximating the function in the first example using a plurality of linear functions (a straight line L1, a straight line L2, and a straight line L3 in the illustrated example). That is, the function used in conversion by the preprocessing unit 21 can also be said to be a piecewise linear function including a plurality of functions having linearity. In other words, the predetermined function having nonlinearity used in conversion by the preprocessing unit 21 can also be said to be approximated by a plurality of functions having linearity.

Similarly to the function in the first example, the function in the second example converts data of 14 [bit] to 8 [bit]. According to the function in the second example, similarly to the function in the first example, values of a higher number of bits after conversion are assigned to an area with low input signal values (that is, a dark area in an image). In the illustrated example, the function in the second example is a piecewise linear function including three functions having linearity, but the function may be constituted by three or more functions or may be a combination of nonlinear functions.

Details of the network unit 22 will be described below with reference back to FIG. 2. The network unit 22 performs a convolutional operation with data of 8 [bit] which is a conversion result from the preprocessing unit 21. The network unit 22 is a neural network (a convolutional neural network (CNN)) including a plurality of arithmetic blocks 220. In the illustrated example, the network unit 22 includes arithmetic blocks 220-1 to 220-7. The arithmetic blocks 220-1 to 220-7 are connected to each other. Each arithmetic block 220 includes an input layer, a convolution layer, a pooling layer, a sampling layer, and an output layer. Each arithmetic block 220 includes at least a convolution layer. Each arithmetic block 220 sets data which is an operation result of a convolutional operation (or a deconvolutional operation) to 16 [bit] and converts data of 16 [bit] to data of 8 [bit] by performing a quantization operation.

Specifically, the network unit 22 has a U-net structure. The U-net structure is an encoder-decoder structure which is laterally symmetric as illustrated in the drawing. A plurality of arithmetic blocks 220 arranged from the left side to the central low side in the drawing are encoders including at least a pooling layer that performs a pooling process on the result of the convolutional operation and performs downsampling. A plurality of arithmetic blocks 220 arranged from the central lower side to the right side in the drawing are decoders including at least an upsampling layer that performs upsampling on the result of the convolutional operation and perform upsampling. The encoder and the decoder may be configured to have a symmetric structure, the pooling layer and the upsampling layer may be configured to have a symmetric structure. With the U-net structure, a feature map generated by the encoder is concatenated, added, or the like to a feature map of the decoder. Specifically, a feature map generated by the encoder is copied, cropped, and concatenated to a feature map of the decoder. Concatenation to the feature map of the decoder may be simply addition. A path along which the feature map generated by the encoder is concatenated to the feature map of the decoder is illustrated as a skip connection SC. In other words, the arithmetic blocks 220 constituting the encoder and the arithmetic blocks 220 constituting the decoder are connected by the skip connection SC. The network unit 22 may have a structure other than the U-net structure. For example, the network unit 22 may have a visual transformer structure.

FIG. 6 is a diagram illustrating a skip connection provided in the network unit according to the embodiment. A generalized skip connection will be described below with reference to the drawing. As illustrated in the drawing, an input (x) skips operations to an output and supplements an operation result of each layer (F(x) in the illustrated example). By adding such a skip connection SC between layers, it is possible to obtain a feature that is strong to gradient vanishing.

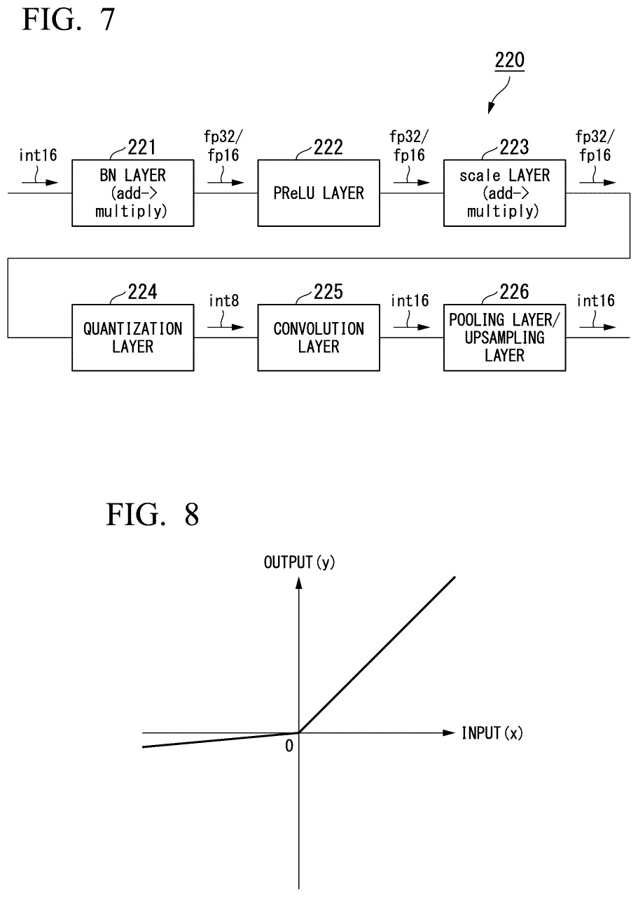

FIG. 7 is a block diagram illustrating an example of a functional configuration of the arithmetic blocks provided in the network unit according to the embodiment. An example of the functional configuration of the arithmetic blocks 220 of the network unit 22 will be described below with reference to the drawing. The functional configuration illustrated in the drawing is an example and may vary depending on a plurality of arithmetic blocks 220 of the network unit 22. Each arithmetic block 220 includes a BN layer 221, a PRELU layer 222, a scale layer 223, a quantization layer 224, a convolution layer 225, and a pooling layer/upsampling layer 226. Output data of an arithmetic block 220 in the previous stage is input to the BN layer 221, and data output from the pooling layer/upsampling layer 226 is input to the subsequent stage. An input from the preprocessing unit 21 is input to the convolution layer 225.

Data of 16 [bit] is input to the batch normalization (BN) layer 221. The BN layer 221 performs normalization of a data distribution on the input data. A predetermined mathematical expression may be used for the normalization process. For example, the BN layer 221 performs addition of a constant and multiplication of a constant for each element such that an average of values of elements in a batch is 0 and a variance of the values of the elements is 1. In the illustrated example, multiplication is performed after addition of a constant has been performed, but the order of addition and multiplication may be inverted (that is, addition may be performed after multiplication has been performed). The constant used for addition and the constant used for multiplication may be floating decimal point type values of 32 [bit] or 16 [bit]. The BN layer 221 outputs floating decimal point type data of 32 [bit] or 16 [bit] to the subsequent stage.

The floating decimal point type data of 32 [bit] or 16 [bit] is input to the PRELU layer 222. The PRELU layer 222 calculates an activation function on the input data.

FIG. 8 is a diagram illustrating an example of an activation function according to the embodiment. An example of the activation function will be described below with reference to the drawing. The horizontal axis represents an input (x), and the vertical axis represents an output (y). In the illustrated example, y=px is established in a range of x<0, and y=px is established in a range of x>0. The activation function is set to a parametric rectified linear unit (PReLU) but may be a rectified linear unit (ReLU) or an identity (transparency). When the slope (p) in the PRELU is set to 0, ReLU is established. When the slope (p) is set to 1, identity is established. The range of the slope (p) may be a real number (floating decimal point type data of 32 [bit] or 16 [bit]) between 0 and 1.

When the network unit 22 is mounted in hardware such as a field programmable gate array (FPGA) or an application-specific integrated circuit (ASIC), the activation function (that is, the PRELU layer 222) may include the BN layer 221. The activation function (that is, the PRELU layer 222) may further include a quantization process.

Referring back to FIG. 7, floating decimal point type data of 32 [bit] or 16 [bit] is input to the scale layer 223. The scale layer 223 performs a scaling process. The scaling process is a process of returning the normalized data to the original data (an inverse process of the batch normalization process). The scale layer 223 performs addition of a constant and multiplication of a constant similarly to the BN layer 221. In the illustrated example, multiplication is performed after addition of a constant has been performed, but the order of addition and multiplication may be inverted (that is, addition may be performed after multiplication has been performed). The constant used for addition and the constant used for multiplication may be floating decimal point type values of 32 [bit] or 16 [bit]. The scale layer 223 outputs floating decimal point type data of 32 [bit] or 16 [bit] to the subsequent stage.

In the arithmetic blocks 220 according to the present embodiment, the BN layer 221 is disposed previous to the PRELU layer 222, and the scale layer 223 is disposed subsequent to the PRELU layer 222. In other words, the process of normalizing a data distribution (encoding) is performed before calculation of the activation function is performed, and the process of returning to the original data using a predetermined function (decoding) is performed after calculation of the activation function is performed. After these processes have been performed, a convolutional operation which will be described later is performed. That is, the network unit 22 according to the present embodiment performs a batch normalization process of normalizing a data distribution, performs calculation of the activation function, performs the scaling process of multiplication by a predetermined function, and then performs a convolutional operation.

Floating decimal point type data of 32 [bit] or 16 [bit] is input to the quantization layer 224. The quantization layer 224 quantizes the input data of 16 or more [bit] to a lower number of bits (for example, 8 or less [bit]). Here, since an output from the preprocessing unit 21 is input to the convolution layer 225, data input to the quantization layer 224 can be said to be a result of at least one convolutional operation. That is, the quantization layer 224 can be said to quantize the data of 16 or more [bit] acquired as the result of the convolutional operation to a lower number of bits (for example, 8 or less [bit]). The quantization process performed by the quantization layer 224 may be performed using one of (1) comparison with a plurality of threshold values and (2) conversion using a predetermined function. The quantization process according to the present embodiment is not limited to that example, and the quantization process may be performed using other quantization. The quantization layer 224 outputs 8-bit integer data to the subsequent stage as a result of the quantization process.

The integer type data of 8 [bit] is input to the convolution layer 225. The convolution layer 225 performs a convolutional operation on the input data. Specifically, the convolution layer 225 performs a convolutional operation using a weight on the input data. Specifically, the convolution layer 225 performs a product-sum operation with the input data and the weight as inputs. The weight (a filter or a kernel) of the convolution layer 225 may be multi-dimensional data including elements which are trainable parameters. The weight of the convolution layer 225 may have a lower number of bits (for example, an integer with a sign of 1 bit added thereto (that is, −1, 1)). The convolution layer 225 outputs integer type data of 16 [bit] to the subsequent stage as a result of the convolutional operation.

The integer type data of 16 [bit] is input to the pooling layer/upsampling layer 226. The pooling layer/upsampling layer 226 performs pooling (downsampling) or upsampling (up-convolution or deconvolution). The pooling layer/upsampling layer 226 is a pooling layer in an encoder and is an upsampling layer in a decoder. The pooling layer/upsampling layer 226 outputs integer type data of 16 [bit] to the subsequent stage as a result of the pooling process (or the upsampling process). The operations or outputs of the convolution layer 225 and the pooling layer/upsampling layer 226 may be not integer type data of 16 [bit], but may be, for example, fixed decimal point type data.

Details of the post-processing unit 23 will be described below with reference back to FIG. 2. The result of the convolutional operation from the network unit 22 and the image (the first image 51) input to the preprocessing unit are input to the post-processing unit 23. The result of the convolutional operation from the network unit 22 includes, that is, information on a noise component included in the first image 51. In other words, the network unit 22 has been trained in advance to extract a noise component included in the first image 51. The post-processing unit 23 generates a high-quality image by subtracting the noise component from the first image 51. That is, the post-processing unit 23 generates a higher-quality image than the image input to the preprocessing unit 21 on the basis of the result of the convolutional operation from the network unit 22 and the image input to the preprocessing unit 21.

Here, the network unit 22 performs processing on the basis of a value converted to the lower number of bits using a predetermined function having nonlinearity by the preprocessing unit 21. The post-processing unit 23 may perform a process of converting an output of the network unit 22 from a nonlinear value to a linear value before performing the process of subtracting the noise component from the first image 51. An inverse function of the function illustrated in FIG. 4 or 5 may be used for this conversion process.

The network unit 22 may perform learning and inference including the conversion process. In this case, the process of converting a nonlinear value to a linear value that is performed by the post-processing unit 23 can be omitted.

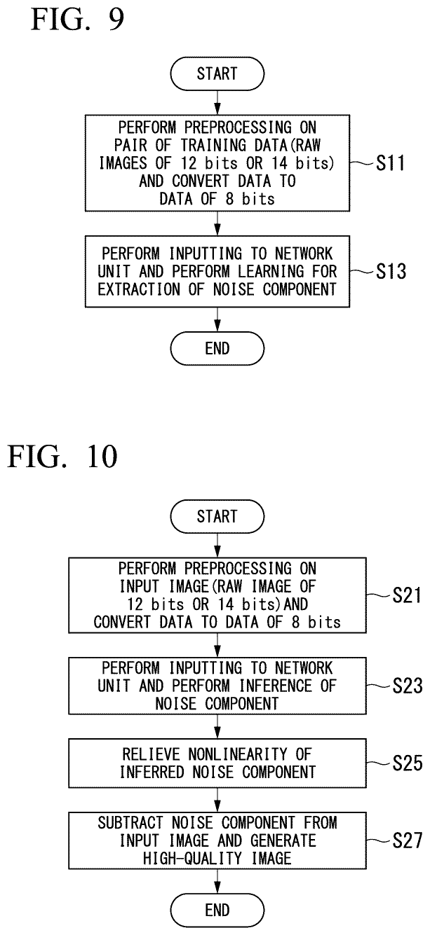

An example of a series of operations in a learning stage and an inference stage of the image processing system 1 according to the present embodiment will be described below with reference to FIGS. 9 to 12. A first example will be first described with reference to FIGS. 9 and 10. In the first example, learning is performed on the basis of the premise that the process of converting a nonlinear value to a linear value is performed in a subsequent process. Accordingly, the process of converting a nonlinear value to a linear value is necessary in a subsequent process.

FIG. 9 is a flowchart illustrating the first example of the process in the learning stage according to the embodiment. A first example of the process in the learning stage of the image processing system 1 will be described below with reference to the drawing.

(Step S11) First, the preprocessing unit 21 performs preprocessing on a RAW image output from the image sensor 10 as an image serving as training data. The training data includes a pair of a high-quality image and a low-quality image. This pair of high-quality image and low-quality image is images in which the same object is imaged, and noise is superimposed on the low-quality image. The low-quality image may be generated by imaging the same subject as the high-quality image using different settings or may be generated by image-processing the high-quality image. Both the high-quality image and the low-quality image included in the training data are RAW images of 12 [bit] or 14 [bit]. Specifically, the preprocessing unit 21 converts pixel values of each of the pair of high-quality image and low-quality image included in the training data to data of fewer bits using a predetermined function having nonlinearity. When the pixel values of an image included in the training data are 12 [bit] or 14 [bit], the preprocessing unit 21 converts the pixel values to data of 8 [bit] which is a lower number of bits than the number of bits of the pixel values of the image included in the training data. The process performed by the preprocessing unit 21 may be referred to as a preprocessing step.

(Step S13) Then, data which is a conversion result in the preprocessing step is input to the network unit 22. The network unit 22 performs learning on the basis of the data which is the conversion result in the preprocessing step. The step of learning in the network unit 22 may be referred to as a learning step. In the learning step, learning for extraction of a noise component superimposed on the low-quality image is performed with the data which is the conversion result in the preprocessing step as an input. Here, in the learning step according to the first example, learning is performed on the basis of data which is a conversion result using a predetermined function having nonlinearity in the preprocessing step. That is, in the inference stage according to the first example, it is necessary to perform conversion for relieving nonlinearity after inference has been performed by the network unit 22. The conversion for relieving nonlinearity may be specifically conversion using an inverse function of the predetermined function having nonlinearity used in the preprocessing step. In the learning step according to the first example, the preprocessing step may be included as a target of learning. For example, parameters such as coefficients or constants of the predetermined function having nonlinearity in the preprocessing step may be learned.

FIG. 10 is a flowchart illustrating a first example of a process in the inference stage according to the embodiment. A first example of the process in the inference stage of the image processing system 1 will be described below with reference to the drawing.

(Step S21) First, the preprocessing unit 21 performs preprocessing of a RAW image output from the image sensor 10 as an image to be image-processed. The image to be image-processed is preferably a low-quality image on which noise has been superimposed. The image to be image-processed is a RAW image of 12 [bit] or 14 [bit]. Specifically, the preprocessing unit 21 converts the pixel values of the image to be image-processed to data of fewer bits using a predetermined function having nonlinearity. When the pixel values of the image to be image-processed are 12 [bit] or 14 [bit], the preprocessing unit 21 converts the pixel values to data of 8 [bit] which is lower than the number of bits of the pixel values of the image to be image-processed.

(Step S23) Then, inference of a noise component is performed using the trained model generated in Step S13 with the data which is the conversion result in the preprocessing step as an input. The step of inferring a noise component may be referred to as an inference step. The data which is the conversion result in the preprocessing step is input to the network unit 22, and the network unit 22 outputs an inference result of the noise component to the post-processing unit 23.

(Step S25) Then, the post-processing unit 23 performs a process of relieving nonlinearity using an inverse function of a predetermined function having nonlinearity on the noise component inferred in the inference step. The inverse function of the predetermined function having nonlinearity may be, that is, an inverse function of the function used in Step S21.

(Step S27) Then, an input image to be image-processed is input to the post-processing unit 23 via the global skip connection GSC. The post-processing unit 23 removes noise from the low-quality image by subtracting the noise component of which nonlinearity has been relieved from the input image to be image-processed (that is, the low-quality image on which noise has been superimposed) and generates an output image with higher quality (higher image quality) than the input image. The step performed in Steps S25 and S27 may be referred to as a post-processing step.

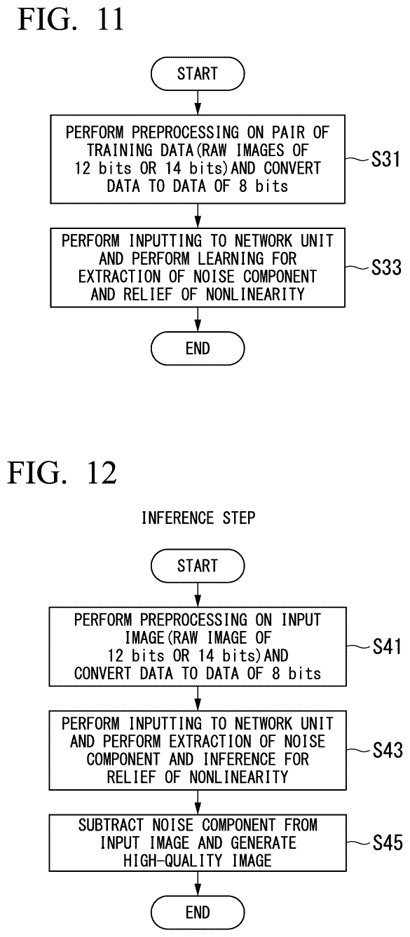

A second example will be described below with reference to FIGS. 11 and 12. In the second example, learning including the process of converting a nonlinear value to a linear value is performed. Accordingly, in the second example, the process of converting a nonlinear value to a linear value is not necessary in a subsequent step.

FIG. 11 is a flowchart illustrating the second example of the process in the learning stage according to the embodiment. The second example of the process in the learning stage of the image processing system 1 will be described below with reference to the drawing.

(Step S31) First, the preprocessing unit 21 performs preprocessing on a RAW image output from the image sensor 10 as an image serving as training data. The training data includes a pair of a high-quality image and a low-quality image. This pair of high-quality image and low-quality image is a pair in which the same object is imaged, and noise is superimposed on the low-quality image. The low-quality image may be generated by imaging the same subject as the high-quality image using different settings or may be generated by image-processing the high-quality image. Both the high-quality image and the low-quality image included in the training data are RAW images of 12 [bit] or 14 [bit]. Specifically, the preprocessing unit 21 converts pixel values of each of the pair of high-quality image and low-quality image included in the training data to data of fewer bits using a predetermined function having nonlinearity. When the pixel values of an image included in the training data are 12 [bit] or 14 [bit], the preprocessing unit 21 converts the pixel values to data of 8 [bit] which is a lower number of bits than the number of bits of the pixel values of the image included in the training data.

(Step S33) Then, data which is a conversion result in the preprocessing step is input to the network unit 22, and the learning step is performed. In the learning step, learning for extraction of a noise component superimposed on the low-quality image is performed with the data which is the conversion result in the preprocessing step as an input. In the learning step according to the second example, learning for conversion using an inverse function of a predetermined function having nonlinearity is performed. That is, in the inference stage according to the second example, since learning for conversion for relieving nonlinearity is also performed, a process of relieving nonlinearity in the post-processing step is not necessary. In the learning step according to the second example, the preprocessing step may be included as a target of learning. For example, parameters such as coefficients or constants of the predetermined function having nonlinearity in the preprocessing step may be learned.

FIG. 12 is a flowchart illustrating a second example of a process in the inference stage according to the embodiment. A second example of the process in the inference stage of the image processing system 1 will be described below with reference to the drawing.

(Step S41) First, the preprocessing unit 21 performs preprocessing of a RAW image output from the image sensor 10 as an image to be image-processed. The image to be image-processed is preferably a low-quality image on which noise has been superimposed. The image to be image-processed is a RAW image of 12 [bit] or 14 [bit]. Specifically, the preprocessing unit 21 converts the pixel values of the image to be image-processed to data of fewer bits using a predetermined function having nonlinearity. When the pixel values of the image to be image-processed are 12 [bit] or 14 [bit], the preprocessing unit 21 converts the pixel values to data of 8 [bit] which is lower than the number of bits of the pixel values of the image to be image-processed.

(Step S43) Then, inference of a noise component is performed using the trained model generated in Step S33 with the data which is the conversion result in the preprocessing step as an input. Since the trained model generated in Step S33 has learned the conversion for relieving nonlinearity, an inference result output from the inference step according to the second example can be said to have been obtained after the conversion for relieving nonlinearity has been already performed. The data which is the conversion result in the preprocessing step is input to the network unit 22, and the network unit 22 outputs an inference result of the noise component to the post-processing unit 23.

(Step S45) Then, an input image to be image-processed is input to the post-processing unit 23 via the global skip connection GSC. The post-processing unit 23 removes noise from the low-quality image by subtracting the inference result of the noise component output from the network unit 22 from the input image to be image-processed (that is, the low-quality image on which noise has been superimposed) and generates an output image with higher quality (higher image quality) than the input image. Step S45 in the second example corresponds to the post-processing step.

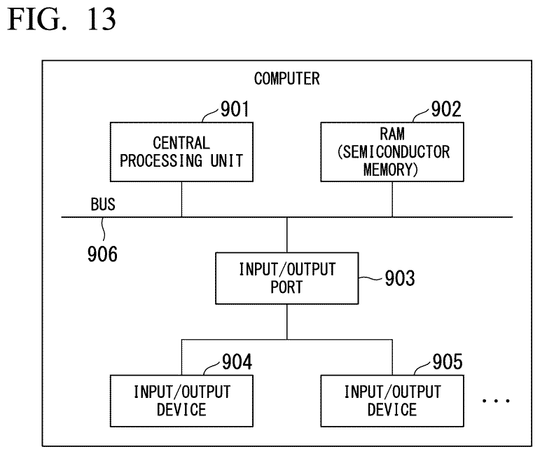

FIG. 13 is a block diagram illustrating an example of an internal configuration of an image processing device, a learning device, and an inference device according to the present embodiment. At least some functions of the image processing device, the learning device, and the inference device can be realized using a computer. As illustrated in the drawing, the computer includes a central processing unit 901, a RAM 902, an input/output port 903, input/output devices 904 and 905, and a bus 906. The computer itself can be realized using known techniques. The central processing unit 901 executes instructions included in a program read from the RAM 902 or the like. The central processing unit 901 writes data to the RAM 902, reads data from the RAM 902, or performs an arithmetic operation or a logical operation in accordance with the instructions. The RAM 902 stores data or programs. Each element included in the RAM 902 has an address and can be accessed using the address. The input/output port 903 is a port for allowing the central processing unit 901 to exchange data with an external input/output device. The input/output devices 904 and 905 are input/output devices. The input/output devices 904 and 905 exchange data with the central processing unit 901 via the input/output port 903. The bus 906 is a shared communication passage which is used in the computer. For example, the central processing unit 901 reads or writes data from or to the RAM 902 via the bus 906. For example the central processing unit 901 accesses the input/output port via the bus 906. All or some of the functional units of the image processing device, the learning device, and the inference device may be realized by hardware such as an application-specific integrated circuit (ASIC), a programmable logic device (PLD), or a field-programmable gate array (FPGA).

### Summary of Embodiment

According to the aforementioned embodiment, the image processing device includes the preprocessing unit 21 to convert pixel values of an input image to data of a lower number of bits than the number of bits of the pixel values of the input image using a predetermined function having nonlinearity. The image processing device includes the network unit 22 to perform a convolutional operation with data which is a result of conversion from the preprocessing unit 21 as an input. That is, with the image processing device according to the present embodiment, an input image is nonlinearly converted and is input to a network. Here, image data acquired by the image sensor 10 such as a CMOS sensor has characteristics which are linear with respect to an input (a light intensity). The image processing device can assign values of more bits to an area in which input signal values are low (that is, a dark area in the image) by performing conversion using a predetermined function having nonlinearity. In a dark area in an image, noise is likely to occur, and processes with higher accuracy are necessary. With the image processing device according to the present embodiment, since values of more bits are assigned to a dark area in an image by performing conversion using a predetermined function having nonlinearity, it is possible to accurately extract a noise component. With the image processing device according to the present embodiment, since conversion to data of fewer bits is performed in the preprocessing previous to the network, it is possible to efficiently perform processing. Accordingly, even when the image processing device according to the present embodiment is assembled into an edge device, it is possible to efficiently operate the image processing device. As a result, with the image processing device according to the present embodiment, it is possible to enhance accuracy and efficiency when a low-quality image is processed into a high-quality image using machine learning.

According to the aforementioned embodiment, the network unit 22 includes a pooling layer performing a pooling process on a result of the convolutional operation and an upsampling layer having a symmetric structure with respect to the pooling layer and upsampling the result of the convolutional operation and has a U-net structure in which the pooling layer and the upsampling layer are connected by a skip connection. With the image processing device according to the present embodiment, since the U-net structure is employed, it is strong to gradient vanishing and it is possible to efficiently perform learning and inference.

According to the aforementioned embodiment, the image processing device further includes the post-processing unit 23 connected to the preprocessing unit 21 via the skip connection GSC. The image processing device further includes the post-processing unit 23 to generate a higher-quality image than the image input to the preprocessing unit 21 on the basis of the result of the convolutional operation from the network unit 22 and the image input to the preprocessing unit 21. Accordingly, with the image processing device according to the present embodiment, it is possible to easily generate a high-quality image by subtracting the extracted noise component from the original input image.

According to the aforementioned embodiment, the predetermined function having nonlinearity used for conversion by the preprocessing unit 21 includes a plurality of functions having linearity. That is, the function used for conversion can be said to be a combination of a plurality of straight lines. Accordingly, with the image processing device according to the present embodiment, it is possible to decrease an arithmetic process load. As a result, with the image processing device according to the present embodiment, it is possible to enhance efficiency when a low-quality image is processed into a high-quality image using machine learning.

According to the aforementioned embodiment, the predetermined function used for conversion of the number of bits by the preprocessing unit 21 is determined (switched) according to a gamma function which is used for a gamma process of the input image by the ISP 30. That is, with the image processing device according to the present embodiment, a noise component is extracted in consideration of the gamma process by performing the preprocessing using a function corresponding to the gamma function used for the gamma process of the input image by the ISP 30. Accordingly, with the image processing device according to the present embodiment, it is possible to accurately extract a noise component. As a result, with the image processing device according to the present embodiment, it is possible to enhance accuracy when a low-quality image is processed into a high-quality image using machine learning.

According to the aforementioned embodiment, the network unit 22 performs a batch normalization process of normalizing a data distribution, calculates an activation function, performs a scaling process of multiplication of a predetermined function, and then performs the convolutional operation. In other words, the batch normalization process and the scaling process are performed before and after calculation of the activation function is performed by the network unit 22. With the image processing device according to the present embodiment, it is possible to enhance accuracy of extraction of a noise component by performing calculation of the activation function on the basis of the normalized data. Accordingly, with the image processing device according to the present embodiment, it is possible to enhance accuracy when a low-quality image is processed into a high-quality image using machine learning.

According to the aforementioned embodiment, the network unit 22 converts the pixel values to data of 16 or more bits as a result of the convolutional operation and quantizes the data of 16 or more bits as the result of the convolutional operation to data of 8 or fewer bits. That is, the network unit 22 extracts the noise component by repeating the convolutional operation and the quantization. Accordingly, with the image processing device according to the present embodiment, it is possible to enhance accuracy and efficiency when a low-quality image is processed into a high-quality image using machine learning.

According to the aforementioned embodiment, the network unit 22 quantizes the data of 16 or more bits acquired as the result of the convolutional operation to data of 8 or fewer bits using one method of (1) comparison with a plurality of threshold values and (2) conversion using a predetermined function. Accordingly, with the image processing device according to the present embodiment, it is possible to easily perform quantization. As a result, with the image processing device according to the present embodiment, it is possible to enhance efficiency when a low-quality image is processed into a high-quality image using machine learning.

According to the aforementioned embodiment, the preprocessing unit 21 converts the pixel values to data of 8 bits, and the network unit 22 performs the convolutional operation with the data of 8 bits which is a result of conversion from the preprocessing unit 21 as an input. That is, with the image processing device according to the present embodiment, data of a lower number of bits than the input image is input to the network unit 22. Accordingly, with the image processing device according to the present embodiment, it is possible to decrease a process load of the network unit 22. As a result, with the image processing device according to the present embodiment, it is possible to enhance efficiency when a low-quality image is processed into a high-quality image using machine learning.

According to the aforementioned embodiment, the learning method according to the present embodiment includes the preprocessing step to convert pixel values of a pair of a high-quality image and a low-quality image included in training data to data of a lower number of bits than the number of bits of the pixel values in an image included in the training data using a predetermined function having nonlinearity. The learning method according to the present embodiment includes the learning step to perform learning for extraction of a noise component superimposed on the low-quality image with data which is a result of conversion from the preprocessing step as an input. That is, with the learning method according to the present embodiment, learning is performed on the basis of the premise that the process of relieving nonlinearity is performed in a subsequent process. Accordingly, with the learning method according to the present embodiment, it is possible to decrease the process load of the network unit 22. As a result, with the learning method according to the present embodiment, it is possible to enhance efficiency when a low-quality image is processed into a high-quality image using machine learning.

According to the aforementioned embodiment, the inference method according to the present embodiment includes the preprocessing step to convert pixel values of an input image to data of a lower number of bits than the number of bits of the pixel values of the input image using a predetermined function having nonlinearity. The inference method according to the present embodiment includes the inference step to perform inference for extraction of a noise component with data which is a result of conversion from the preprocessing step as an input. The inference method according to the present embodiment includes the post-processing step to generate a high-quality output image than the input image by performing a process of relieving nonlinearity on the inferred noise component using an inverse function of the predetermined function having nonlinearity and subtracting the noise component of which nonlinearity has been relieved from the input image. That is, with the inference method according to the present embodiment, inference is performed on the basis of the premise that the process of relieving nonlinearity is performed in a subsequent process. Accordingly, with the inference method according to the present embodiment, it is possible to decrease the process load of the network unit 22. As a result, with the inference method according to the present embodiment, it is possible to enhance efficiency when a low-quality image is processed into a high-quality image using machine learning.

According to the aforementioned embodiment, the learning method according to the present embodiment includes the preprocessing step to convert pixel values of a pair of a high-quality image and a low-quality image included in training data to data of a lower number of bits than the number of bits of the pixel values of an image included in the training data using a predetermined function having nonlinearity. The learning method according to the present embodiment includes the learning step to perform learning for extraction of a noise component superimposed on the low-quality image and conversion using an inverse function of the predetermined function having nonlinearity with data which is a result of conversion from the preprocessing step as an input. That is, with the learning method according to the present embodiment, learning is performed to include a conversion process using an inverse function of the predetermined function having nonlinearity. Accordingly, with the learning method according to the present embodiment, it is possible to decrease the process load of the post-processing unit 23. As a result, with the learning method according to the present embodiment, it is possible to enhance efficiency when a low-quality image is processed into a high-quality image using machine learning.

According to the aforementioned embodiment, the inference method according to the present embodiment includes the preprocessing step to convert pixel values of an input image to data of a lower number of bits than the number of bits of the pixel values of the input image using a predetermined function having nonlinearity. The inference method according to the present embodiment the inference step to perform inference for extraction of a noise component and conversion using an inverse function of the predetermined function having nonlinearity with data which is a result of conversion from the preprocessing step as an input. The inference method according to the present embodiment includes the post-processing step to generate a high-quality output image than the input image by subtracting the inferred noise component from the input image. That is, with the inference method according to the present embodiment, inference is performed using a trained model having learned a conversion process using an inverse function of the predetermined function having nonlinearity. Accordingly, with the inference method according to the present embodiment, it is possible to decrease the process load of the post-processing unit 23. As a result, with the inference method according to the present embodiment, it is possible to enhance efficiency when a low-quality image is processed into a high-quality image using machine learning.

The learning target of the image processing device, the learning device, and the inference device according to the present embodiment may include a weight, a quantization parameter, a batch normalization process, and a scaling process.

All or some of the functions of the constituent units provided in the image processing device, the learning device, and the inference device according to the aforementioned embodiments may be realized by recording programs for realizing these functions on a computer-readable recording medium and causing a computer system to read and execute the programs recorded on the recording medium. The “computer system” mentioned herein includes an OS or hardware such as peripherals.

The “computer-readable recording medium” is a portable medium such as a flexible disk, a magneto-optical disc, a ROM, or a CD-ROM or a storage device such as a hard disk incorporated into a computer system. The “computer-readable recording medium” may include a medium that dynamically holds a program for a short time such as a communication line when the program is transmitted via a network such as the Internet or a communication circuit line such as a telephone line or a medium that holds a program for a predetermined time such as a volatile memory in a computer system serving as a server or a client in that case. The program may be a program for realizing some of the aforementioned functions or may be a program for realizing the aforementioned functions in combination with another program stored in advance in the computer system.

While the present invention has been described above in conjunction with embodiments, the present invention is not limited to these embodiments, and various modifications and substitutions can be added thereto without departing from the gist of the present invention

### INDUSTRIAL APPLICABILITY

According to the present invention, it is possible to enhance accuracy and efficiency when a low-quality image is processed into a high-quality image using machine learning.

### REFERENCE SIGNS LIST

1 Image processing system
10 Image sensor
20 Processing unit
21 Preprocessing unit
22 Network unit
220 Arithmetic block
221 BN layer
222 PRELU layer
223 Scale layer
224 Quantization layer
225 Convolution layer
226 Pooling layer/upsampling layer
23 Post-processing unit
30 ISP
40 Memory
51 First image
52 Second image
53 Third image
SC Skip connection
GSC Global skip connection

1. An image processing device comprising:
a preprocessing unit configured to convert pixel values of an input image to data of a lower number of bits than the number of bits of the pixel values using a predetermined function having nonlinearity; and
a network unit configured to perform a convolutional operation with data which is a result of conversion from the preprocessing unit as an input.

2. The image processing device according to claim 1, wherein the network unit includes a pooling layer performing a pooling process on a result of the convolutional operation and an upsampling layer having a symmetric structure with respect to the pooling layer and upsampling the result of the convolutional operation and has a U-Net structure in which the pooling layer and the upsampling layer are connected by a skip connection.

3. The image processing device according to claim 1, further comprising a post-processing unit configured to generate a higher-quality image than the image input to the preprocessing unit on the basis of the result of the convolutional operation from the network unit and the image input to the preprocessing unit.

4. The image processing device according to claim 1, wherein the predetermined function having nonlinearity used for conversion by the preprocessing unit is configured to be approximated by a plurality of functions having linearity.

5. The image processing device according to claim 1, wherein the predetermined function used for conversion of the number of bits by the preprocessing unit is determined according to a gamma function which is used for a gamma process of the input image.

6. The image processing device according to claim 1, wherein the network unit performs a batch normalization process of normalizing a data distribution, calculates an activation function, performs a scaling process of multiplication of a predetermined function, and then performs the convolutional operation.

7. The image processing device according to claim 1, wherein the network unit converts the pixel values to data of 16 or more bits as a result of the convolutional operation and quantizes the data of 16 or more bits as the result of the convolutional operation to data of 8 or fewer bits.

8. The image processing device according to claim 7, wherein the network unit quantizes the data of 16 or more bits acquired as the result of the convolutional operation to data of 8 or fewer bits using one method of comparison with a plurality of threshold values and conversion using a predetermined function.

9. The image processing device according to claim 1, wherein the preprocessing unit converts the pixel values to data of 8 bits, and
wherein the network unit performs the convolutional operation with the data of 8 bits which is a result of conversion from the preprocessing unit as an input.

10. A learning method comprising:
a preprocessing step of converting pixel values of a pair of a high-quality image and a low-quality image included in training data to data of a lower number of bits than the number of bits of the pixel values using a predetermined function having nonlinearity; and
a learning step of performing learning for extraction of a noise component superimposed on the low-quality image with data which is a result of conversion from the preprocessing step as an input.

11. An inference method comprising:
a preprocessing step of converting pixel values of an input image to data of a lower number of bits than the number of bits of the pixel values using a predetermined function having nonlinearity;
an inference step of performing inference for extraction of a noise component with data which is a result of conversion from the preprocessing step as an input; and
a post-processing step of generating a high-quality output image than the input image by performing a process of relieving nonlinearity on the inferred noise component using an inverse function of the predetermined function having nonlinearity and subtracting the noise component of which nonlinearity has been relieved from the input image.

12. A learning method comprising:
a preprocessing step of converting pixel values of a pair of a high-quality image and a low-quality image included in training data to data of a lower number of bits than the number of bits of the pixel values using a predetermined function having nonlinearity; and
a learning step of performing learning for extraction of a noise component superimposed on the low-quality image and conversion using an inverse function of the predetermined function having nonlinearity with data which is a result of conversion from the preprocessing step as an input.

13. An inference method comprising:
a preprocessing step of converting pixel values of an input image to data of a lower number of bits than the number of bits of the pixel values using a predetermined function having nonlinearity;
an inference step of performing inference for extraction of a noise component and conversion using an inverse function of the predetermined function having nonlinearity with data which is a result of conversion from the preprocessing step as an input; and
a post-processing step of generating a high-quality output image than the input image by subtracting the inferred noise component from the input image.
